(19) United States
(12) Patent Application Publication
(10) Pub. No.: US 2013/0090015 A1
(43) Pub. Date: Apr. 11, 2013

(54) Double Male Adaptor

(71) Applicants: Tina Monson, Rolla, MO (US); Thomas Monson, Rolla, MO (US)

(72) Inventors: Tina Monson, Rolla, MO (US); Thomas Monson, Rolla, MO (US)

(21) Appl. No.: 13/625,056

(22) Filed: Sep. 24, 2012

Related U.S. Application Data
(60) Provisional application No. 61/545,274, filed on Oct. 10, 2011.

(51) Int. Cl. H01R 31/06

(52) U.S. Cl. 439/628

(57) ABSTRACT

A male adaptor device is disclosed that is designed for connecting a female receptacle to a wall receptacle. The male adaptor device comprises a housing unit that encases a two-pronged male plug and a three-pronged male plug, wherein the two-pronged male plug and the three-pronged male plug are in electrical communication with one another. The two-pronged male plug is typically secured to and recessed in a first end of the housing unit. Further, the three-pronged male plug is typically secured to a second end of the housing unit. The male adaptor device also comprises a cap utilized to cover the three-pronged male plug in the second end of the housing unit. The male adaptor device further comprises an on/off power switch and a female receptacle positioned on an outside surface of the housing unit.

### CROSS-REFERENCE

This application claims priority from Provisional Patent Application Ser. No. 61/545,274 filed Oct. 10, 2011.

### BACKGROUND

Christmas lights and other electric cords are typically sold in long strings with a female electrical receptor on one end and a male electrical plug on the opposite end of the strand or cord so that the strands can be electrically connected in series. However, people often start decorating without looking at what is on either end of the string of lights. When it comes time to plug in the lights or connect the same electrically, the individuals may be left with the female receptacle end that cannot plug into the wall receptacle. Then, the individuals may be forced to take down the Christmas lights or electronics and start again, which can be both frustrating and time consuming. Also, individuals may argue about who should perform the task of re-hanging the Christmas lights or electronics, which may lead to tension in the household. Furthermore, instead of redoing the work, an individual may try to open the wires and create his or her own adaptor, which can be dangerous. A safer, more efficient solution is necessary.

There is a need for an improved double male adaptor device that may alleviate some of the frustration that comes with hanging Christmas lights or connecting electronics from the incorrect end of an electric cord. The present invention may be used with any standard outlet and was designed for safety. The housing of the male adaptor device has a recessed male plug that is used to keep children and other individuals from receiving an electric shock. Further, the device may include a power switch that turns the device on or off. Any busy home or business owner who wants to hang and illuminate their Christmas lights or connect electronics without the hassle and frustration of repeated work may appreciate this invention.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a male adaptor device that is designed for connecting a female receptacle to a wall receptacle. The male adaptor device comprises a housing unit comprising a first end and a second end. The housing unit encases a two-pronged male plug and a three-pronged male plug, wherein the two-pronged male plug and the three-pronged male plug are in electrical communication with one another. The two-pronged male plug is typically secured to and recessed in the first end of the housing unit. Further, the three-pronged male plug is typically secured to the second end of the housing unit.

In a preferred embodiment, the male adaptor device also comprises a cap. When not in use, the cap covers the three-pronged male plug of the male adaptor device. During use, the cap is utilized to cover the two-pronged male plug at the end of a Christmas light strand or other electric cord. The male adaptor device further comprises an on/off power switch for controlling power to the male adaptor device. The on/off power switch is positioned on an outside surface of the housing unit for easy access by the user. Furthermore, the male adaptor device comprise a female receptacle positioned on an outside surface of the housing unit, opposite the on/off power switch. The female receptacle allows an additional electric cord having a male plug end to be connected to the male adaptor device and powered.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIGS. 1A-B illustrates a perspective view of a male adaptor device in accordance with the disclosed architecture.

FIG. 2 illustrates a perspective view of the male adaptor device comprising an on/off power switch and a female receptacle in accordance with the disclosed architecture.

FIG. 3 illustrates a perspective view of the male adaptor device in an upright position and comprising an on/off power switch and a female receptacle in accordance with the disclosed architecture.

FIG. 4 illustrates a perspective view of the male adaptor device in use in accordance with the disclosed architecture.

FIG. 5 illustrates a perspective view of the male adaptor device in use in accordance with the disclosed architecture.

FIG. 6 illustrates a perspective view of the inside of the cap of the male adaptor device in accordance with the disclosed architecture.

FIG. 7 illustrates a perspective view of the cap positioned on an electric cord in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a male adaptor device that alleviates some of the frustration that comes with hanging Christmas and/or other decorative lights or connecting electronics from the incorrect end of an electric cord. The male adaptor device comprises a housing unit that encases a two-pronged male plug and a three-pronged male plug, wherein the two-pronged male plug and the three-pronged male plug are in electrical communication with one another. The two-pronged male plug is typically secured to and recessed in a first end of the housing unit. Further, the three-pronged male plug is typically secured to a second end of the housing unit. The male adaptor device also comprises a cap that is placed over the three-pronged end of the adaptor which is taken off before use and placed on the two-pronged male plug of an electric cord, such as a strand of Christmas lights. The cap needs to be placed on the two-pronged male plug end of the electric cord before the adaptor is energized. The male adaptor device further comprises an on/off power switch and a female receptacle positioned on an outside surface of the housing unit.

Thus, the male adaptor device may be used with any standard outlet and was designed for safety. The recessed male plug, the cap, and the power switch of the male adaptor device provide protection against electric shock. Accordingly, any busy home or business owner who wants to hang and illuminate their Christmas lights or connect electronics without the hassle and frustration of repeated work may appreciate this invention.

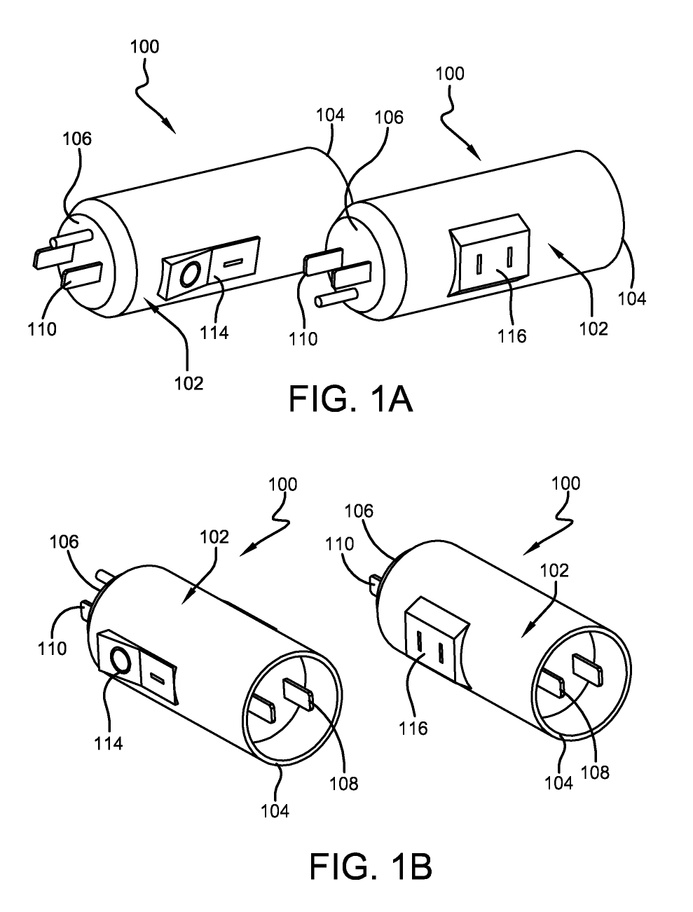

Referring initially to the drawings, FIG. 1 illustrates a male adaptor device 100 that is designed for connecting a female receptacle to a household outlet. The male adaptor device 100 comprises a housing unit 102 comprising a first end 104 and a second end 106. Typically, the housing unit 102 is cylindrical in shape, however any other suitable shape can be used as is known in the art without affecting the overall concept of the invention.

The housing unit 102 would generally be constructed of hard plastic, such as polycarbonate, polyvinyl chloride (PVC), or acrylonitrile butadiene styrene (ABS), though any other suitable material may be used to manufacture the housing unit 102 as is known in the art without affecting the overall concept of the invention. The housing unit 102 is approximately between 1½ and 2 inches long as measured from the first end 104 to the second end 106, and approximately between 1¼ and 2¼ (which includes the switch) inches in diameter.

Furthermore, the housing unit 102 is typically comprised of two sections (not shown) mated together via snapping together recesses and corresponding tabs located on the perimeter of the sections, though any other suitable means of fastening the sections together may be used such as gluing, screwing, etc. Optionally, the housing unit 102 can be manufactured as an integral unit instead of two separate sections.

The housing unit 102 encases a two-pronged male plug 108 and a three-pronged male plug 110, wherein the two-pronged male plug 108 and the three-pronged male plug 110 are in electrical communication with one another. The two-pronged male plug 108 is typically secured to the first end 104 of the housing unit 102 and is recessed in the first end 104 of the housing unit 102. The two-pronged male plug 108 is recessed in the first end 104 of the housing unit 102 to protect a user's exposure to the live electrical connection produced when the male adaptor device 100 is plugged into a wall receptacle. Further, the three-pronged male plug 110 is typically secured to the second end 106 of the housing unit. However, the two-pronged 108 and three-pronged 110 male plugs can be secured to either side of the housing unit 102 without affecting the overall concept of the invention.

The two-pronged male plug 108 and the three-pronged male plug 110 are in electrical communication with one another via copper wiring, or a copper or tin plated bar, or any other means for creating an electrical communication between the two-pronged 108 and three-pronged 110 male plugs. If copper wiring is used to establish the electrical communication between the two-pronged 108 and three-pronged 110 male plugs, then the copper wiring is secured together via crimping, soldering, twisting, etc., or any other suitable means for fastening the wire together as is known in the art without affecting the overall concept of the invention. Furthermore, the housing unit 102 also encases the copper wiring or other means for creating an electrical communication between the two-pronged 108 and three-pronged 110 male plugs. Additionally, the three-pronged male plug 110 provides the ground for the male adaptor device 100. The device grounds when you plug it into a grounded wall receptacle.

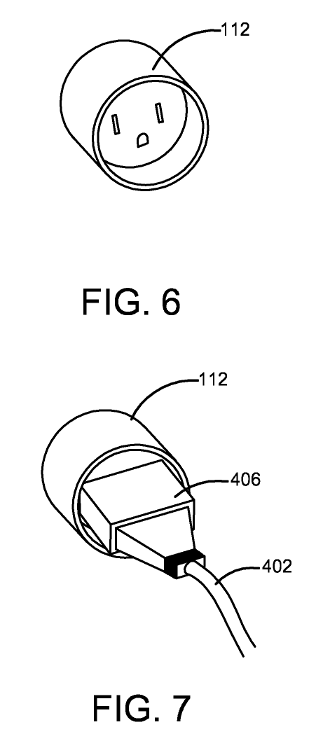

Further, the male adaptor device 100 comprises a cap 112 (as shown in FIGS. 3 and 6). The cap 112 would generally be constructed of hard plastic, such as polycarbonate, polyvinyl chloride (PVC), or acrylonitrile butadiene styrene (ABS), though any other suitable material may be used to manufacture the cap 112 as is known in the art without affecting the overall concept of the invention. As shown in FIG. 6, the inside of the cap 112 typically comprises a three-pronged outlet or receptacle for accepting a three-pronged or two-pronged plug. Further, the cap 112 is sized to cover an end 106 of the housing unit 102. Specifically, the cap 112 is placed over the three-pronged male plug 110 of the adaptor device 100 and is taken off before use and then placed on the two-pronged male plug 406 of an electric cord 402 (as shown in FIG. 7). The cap 112 needs to be placed on the two-pronged male plug 406 before the adaptor device 100 is energized. The cap 112 protects a user's exposure to the live electrical connection produced when the male adaptor device 100 is plugged into a wall receptacle.

The male adaptor device 100 further comprises an on/off power switch 114 for controlling power to the male adaptor device 100. The on/off power switch 114 is positioned on an outside surface of the housing unit 102, and can be a toggle switch, separate on/off buttons, etc., or any other suitable switching means as is known in the art. The on/off power switch 114 may be utilized to control power to the male adaptor device 100 for facilitating and/or interrupting a power supply. If the ‘off’ button of the power switch 114 is pressed down, then the male adaptor device 100 can be plugged into a wall receptacle and will not provide power till the ‘on’ button of the power switch 114 is pressed down.

Furthermore, the male adaptor device 100 comprises a female receptacle 116. The female receptacle is positioned on an outside surface of the housing unit 102, generally opposite the on/off power switch 114, or the female receptacle 116 can be positioned at any other suitable location on the outside surface of the housing unit 102 as is known in the art without affecting the overall concept of the invention. The female receptacle 116 is in electrical communication with the three-pronged male plug 110 and thus, allows an additional electric cord having a male plug end to be connected to the male adaptor device 100 and powered. Furthermore, the male adaptor device 100 can comprise more than one female receptacle 116 if necessary, or a user can attach a two-prong triple female adaptors (as is known in the art) to the male adaptor device 100 if additional receptacles are needed.

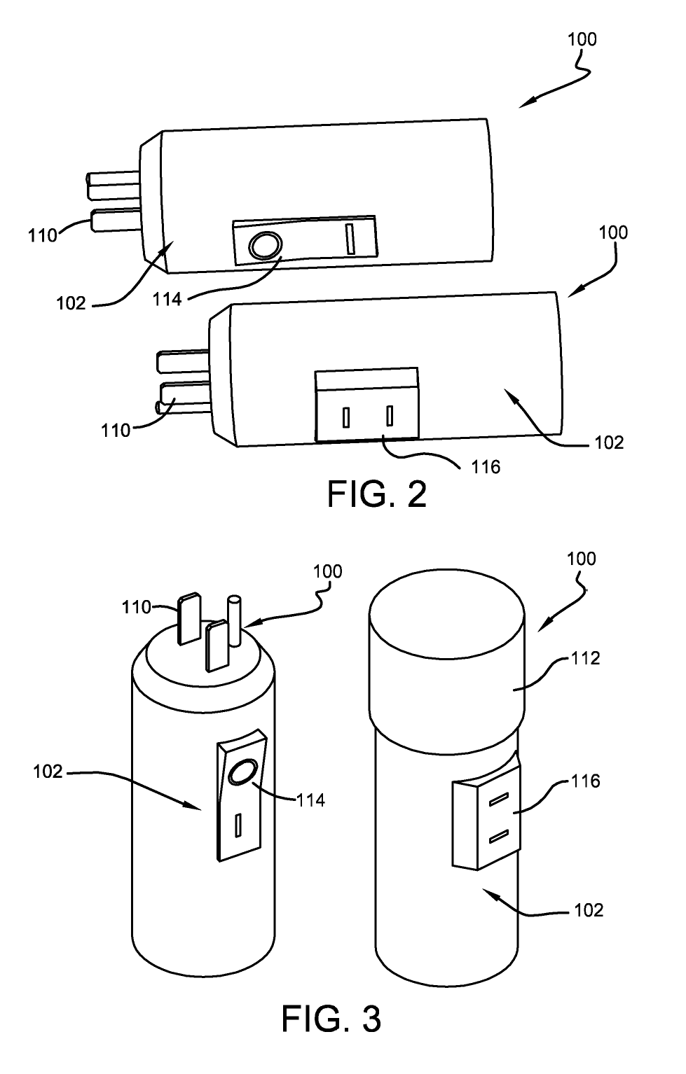

FIGS. 2-3 illustrate the male adaptor device 100 comprising an on/off power switch 114 and a female receptacle 116. The on/off power switch 114 controls power to the male adaptor device 100. The on/off power switch 114 is positioned on an outside surface of the housing unit 102, and can be a toggle switch, separate on/off buttons, etc., or any other suitable switching means as is known in the art. The on/off power switch 114 may be utilized to control power to the male adaptor device 100. If the ‘off’ button of the power switch 114 is pressed down, then the power is interrupted until the circuit is closed again (i.e., the ‘on’ button is pressed down).

Thus, the male adaptor device 100 can be plugged into a wall receptacle, but will not provide power till the ‘on’ button of the power switch 114 is pressed down (or the circuit is closed). Accordingly, a user may plug in a string of lights (or other electric cord) with a female receptacle into the recessed two-pronged male plug and then plug the three-pronged male plug 110 of the male adaptor device 100 into the wall receptacle. Then, once the on/off power switch 114 has been turned to ‘on’, the lights will work as usual. Thus, the on/off switch is an additional safety device in that you can have the switch turned off before plugging it into the wall receptacle. Additionally, the on/off power switch 114 can be made to light up, such that it would be easier to see the on/off power switch 114, to see if the male adaptor device 100 is on or off.

Furthermore, the male adaptor device 100 comprises a female receptacle 116. The female receptacle is positioned on an outside surface of the housing unit 102, opposite the on/off power switch 114, or the female receptacle 116 can be positioned at any other suitable location on the outside surface of the housing unit 102 as is known in the art without affecting the overall concept of the invention. The female receptacle 116 allows an additional electric cord having a male plug end to be connected to the male adaptor device 100 and powered.

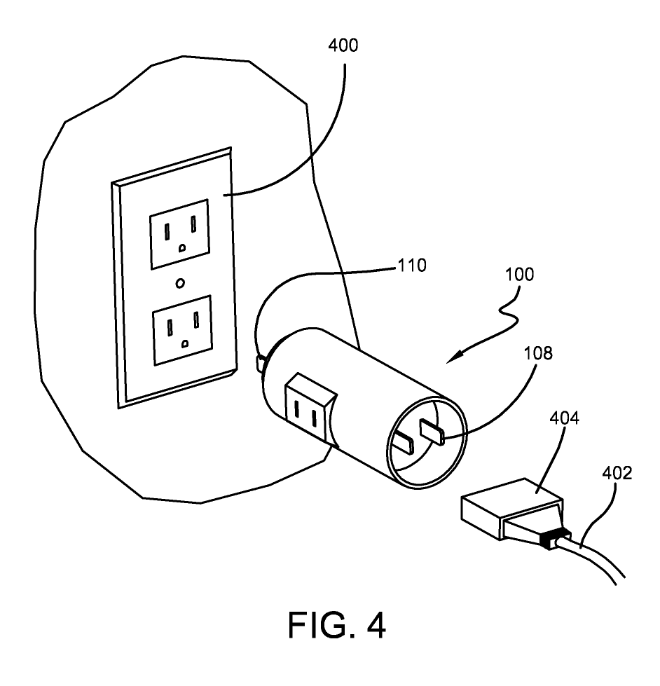

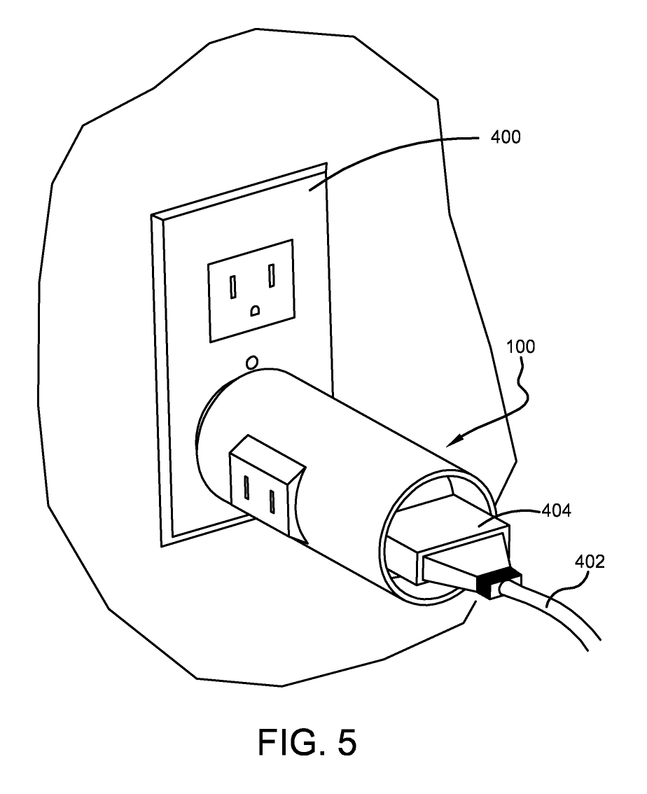

FIGS. 4-5 illustrate the male adaptor device 100 in use. In operation, a user would select a male adaptor device 100. A user would then select a desired electric cord 402 with an end comprising at least one female receptacle 404, such as a string of Christmas lights or an extension cord, etc. A user would then remove the cap 112 (as shown in FIG. 7) which was placed over the three-pronged male plug 110 of the adaptor device 100 and place it on the two-pronged male plug 406 (as shown in FIG. 7) of the electric cord 402. The cap 112 needs to be placed on the two-pronged male plug 406 before the adaptor device 100 is energized. A user would then turn the power of the male adaptor device 100 to ‘off’ via pressing the ‘off’ button (i.e., opening the circuit). The user would then plug the female receptacle 404 of the electric cord 402 into the recessed two-pronged male plug 108 and then would plug the three-pronged male plug 110 of the male adaptor device 100 into the wall receptacle 400. The user then presses the ‘on’ button (i.e., closing the circuit), which provides power to the male adaptor device 100 and the electric cord 402, allowing the string of Christmas lights to light, or powering the extension cord, etc.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A male adaptor device comprising:
a 2-pronged male plug; and
a 3-pronged male plug in electrical communication with the 2-pronged male plug; and
a housing unit which encases the 2-pronged male receptacle and the 3-pronged male receptacle and electrical wiring which connects the 2-pronged male receptacle and the 3-pronged male receptacle.

2. The male adaptor device of claim 1, further comprising a female receptacle.

3. The male adaptor device of claim 2, wherein the female receptacle is located on an outside surface of the housing unit and is in electrical communication with the 3-pronged male plug.

4. The male adaptor device of claim 3, further comprising an on/off power switch.

5. The male adaptor device of claim 4, wherein the on/off power switch is located on an outside surface of the housing unit, generally opposite of the female receptacle.

6. The male adaptor device of claim 1, wherein the housing unit comprises two sections mated together.

7. The male adaptor device of claim 1, wherein the 3-pronged male plug is located on a second end of the housing unit.

8. The male adaptor device of claim 1, wherein the 2-pronged male plug is recessed in a first end of the housing unit.

9. The male adaptor device of claim 8, further comprising a cap located on the second end of the housing unit that covers the 3-pronged male plug.

10. A male adaptor device comprising:
a 2-pronged male receptacle;
a 3-pronged male receptacle in electrical communication with the 2-pronged male receptacle;
an on/off power switch; and
a housing unit which encases the 2-pronged male receptacle and the 3-pronged male receptacle and electrical wiring which connects the 2-pronged male receptacle and the 3-pronged male receptacle.

11. The male adaptor device of claim 10, further comprising a female receptacle.

12. The male adaptor device of claim 11, wherein the female receptacle is located on an outside surface of the housing unit.

13. The male adaptor device of claim 10, wherein the 2-pronged male receptacle is recessed in a first end of the housing unit.

14. The male adaptor device of claim 10, wherein the 3-pronged male receptacle is located on a second end of the housing unit.

15. The male adaptor device of claim 10, wherein the on/off power switch is located on an outside surface of the housing unit.

16. A male adaptor device comprising:
a 2-pronged male receptacle;
a 3-pronged male receptacle in electrical communication with the 2-pronged male receptacle;
an on/off power switch;
a female receptacle; and
a housing unit which encases the 2-pronged male receptacle and the 3-pronged male receptacle and electrical wiring which connects the 2-pronged male receptacle and the 3-pronged male receptacle.

17. The male adaptor device of claim 16, wherein the female receptacle is located on an outside surface of the housing unit.

18. The male adaptor device of claim 16, wherein the on/off power switch is located on an outside surface of the housing unit.

19. The male adaptor device of claim 16, wherein the 2-pronged male receptacle is recessed in a first end of the housing unit.

20. The male adaptor device of claim 16, wherein the 3-pronged male receptacle is located on a second end of the housing unit.
